(19) United States
(12) Patent Application Publication
(10) Pub. No.: US 2012/0281933 A1
(43) Pub. Date: Nov. 8, 2012

(54) THIN FLEXIBLE ONE-WAY VALVE, PACKAGING INCLUDING THE SAME, AND METHOD OF MAKING THE SAME

(75) Inventor: Jeffrey Scott Beer, Coopersburg, PA (US)

(73) Assignee: FRES-CO SYSTEM USA, INC., Telford, PA (US)

(21) Appl. No.: 13/447,640

(22) Filed: Apr. 16, 2012

Related U.S. Application Data
(60) Provisional application No. 61/483,360, filed on May 6, 2011.

(51) Int. Cl. B65D 30/26; B31B 1/84; F16K 15/14

(52) U.S. Cl. 383/45; 383/49; 137/844; 493/213

(57) ABSTRACT

A one-way valve is mounted over a vent hole in a flexible package to enable gases to vent. The valve has a flexible base layer, a flexible cover layer and an interposed layer of oil. Each layer has an opposed pair of side edges. The cover layer is thinner than the base layer and is secured to the base layer along respective contiguous portions of the side edges to form an openable channel. The oil layer is located in the channel between the base layer and the cover layer and over the hole to form a bond holding the cover layer on the base layer until pressure within the package causes the bond to break, whereupon the cover layer to lift ups and opens the hole valve. Methods of making the package and valve are also disclosed.

### CROSS-REFERENCE TO RELATED APPLICATIONS

This application claims priority from Provisional Application Ser. No. 61/483,360, filed on May 6, 2011, entitled Thin Flexible One-Way Valve, Packaging Including the Same, and Method of Making the Same, which application is assigned to the same assignee as this application and whose disclosure is incorporated by reference herein.

### BACKGROUND OF THE INVENTION

1. Field of the Invention

This invention relates generally to flexible packages and more particularly to degassing valves for use in flexible packaging, packages including such valves and methods of making such valves.

2. Description of Related Art

Packages made out of flexible material are commonly used to store products to isolate the products from the ambient atmosphere. Those products may be agricultural products, foodstuffs, chemicals, etc. It is a common practice to include in various types of flexible packages a valve to enable air which may be trapped within the bag or gases produced by the contents of the bag to exit the bag through the valve while precluding the ambient atmosphere, e.g., air, from entering into the bag through the valve. Examples of such degassing valves are those sold by Pacific Bag, Inc., of Bellevue, Wash. SIG-Schweizerische Industrie-Besellschaft, of Heuhausen am Rheinfall, Switzerland, also sells such valves (e.g., the valve disclosed in U.S. Pat. No. 4,420,015). Wipf AG Verpackungen, of Volketswil, Switzerland, also sells such valves (e.g., the valve disclosed in U.S. Pat. No. 4,444,219). Luigi Goglio Milano, SPA, of Milan, Italy also sells such valves (e.g., the valve disclosed in U.S. Pat. No. 3,799,427, as well as other valves).

Other examples of one-way valves for packages are also found in the following U.S. Pat. No. 3,595,467 (Goglio); U.S. Pat. No. 4,576,285 (Goglio); and U.S. Pat. No. 4,705,174 (Goglio).

All of the foregoing prior art valves are composed substantially thick rigid plastic materials making them impractical for application to packaging materials that are then wound onto a roll. There are several valves on the market that which are somewhat thinner, but are still rather inflexible, such as those disclosed in U.S. Pat. No. 5,427,839 (Buchner), U.S. Pat. No. 4,122,993 (Glas), and U.S. Pat. No. 7,178,555 (Engel). Each of those valves utilizes a rigid separation layer between the base material and the top film. While each of the Buchner, Glas and Engel valves, with their rigid separation layers, tend to function well when stationary and flat, when bended, as can occur when they are attached to flexible packaging material, they tend to leak as the rigid separation layer causes the top layer to separate from the base layer.

Thus, a need presently exists for a valve which is simple in construction, can be made easily and inexpensively, is thin and flexible enabling it to be applied to packaging material to prevent leakage through the valve even when the packaging and the valve is bent, yet which operates effectively and repeatedly under various conditions of service.

The subject invention addresses those needs.

### SUMMARY OF THE INVENTION

One aspect of this invention entails a one-way valve for use on package having an interior for holding a product, e.g., coffee, therein. The package has a wall panel bounding an interior in which the material is located. The valve comprises a base layer, a cover layer and a layer of oil, e.g., silicone oil. The base layer is formed of a thin flexible planar sheet of plastic, e.g., polyester, film having a predetermined, e.g., square, shape an opposed pair of edges, a first side, a second side and a hole extending through said base layer from said first side to said second side. The cover layer is formed of a thin flexible planar sheet of plastic e.g., polyester, film having a predetermined, e.g., square, shape having an opposed pair of edges, a first side and a second side. The cover layer is disposed over the base layer with the second side of the cover layer secured to the first side of the base layer along the opposed pair of edges, whereupon portions of the cover layer and the base layer located between the opposed pair of edges are unsecured to form a channel. The channel has at least one openable end. The layer of oil is located in the channel between the base layer and the cover layer and over the hole.

The wall panel of the package includes an outer surface and at least one aperture or vent hole extending from the outer surface to the interior of the package. The one-way valve is arranged to be secured to the outer surface of the package by a layer of adhesive interposed between the second surface of the base layer and the outer surface of the wall panel, and with the hole in the base layer in fluid communication with the aperture in the wall panel.

Another aspect of this invention is a flexible package including a one-way valve constructed in accordance with the first aspect of this invention.

Another aspect of this invention is a method of assembling the one-way valve and package. That method basically entails providing a carrier web on which a base layer formed of a thin flexible planar sheet of plastic film is releasably mounted. The base layer has a predetermined shape, an opposed pair of edges, a first side and a second side. A hole is formed through the sheet of the base layer from the first side to the second side. Respective strips of adhesive are applied on the first side of the base layer adjacent respective ones of the opposed pair of side edges. A cover layer formed of a thin flexible planar sheet of plastic and having a predetermined shape, an opposed pair of edges, a first side and a second side is provided and disposed over the base layer to form the valve, whereupon the adhesive strips adhesively secure the first side of the base layer to the second side of the cover layer along the opposed pair of edges, with portions of the cover layer and the base layer located between the opposed pair of edges being unsecured to form a channel. The channel has at least one openable end. An aperture is provided in the wall panel of said package. The wall panel has an outer surface. The valve is removed from the carrier web, a layer of oil is introduced into the channel, e.g., applied to the hole, and the valve is then adhesively secured to the outer surface of the wall panel of the package.

In accordance with one preferred aspect of the method of this invention the base layer comprises a pressure sensitive adhesive located on the second side of the base layer. The pressure sensitive adhesive releasably secures the base layer to the carrier web and remains on the second side of the base layer after the valve is removed from the carrier web, whereupon the pressure sensitive adhesive is used to adhesively secure the valve to the outer surface of said wall panel.

In accordance with another preferred aspect of the method of this invention plural base layers are disposed at spaced apart locations on the carrier web to be secured to plural cover layers to form a plurality of valves. To that end, a web of film for forming series of wall panels of respective flexible packages is provided in a continuous strip. The plural valves are applied to the web and the resulting continuous strip rolled up into a reel. The web can then be unreeled and each package cut from the web, filled and sealed.

### DESCRIPTION OF THE DRAWING

FIG. 1 is a top plan view of one exemplary flexible package including a valve constructed in accordance with this invention shown mounted on one of the walls the package;

FIG. 2 is an enlarged sectional view taken along line 2-2 of FIG. 1.

FIG. 3 is a slightly reduced top plan view of one portion, e.g., the base layer, of the valve shown in FIG. 1 in the process of being fabricated for assembly to another portion of the valve;

FIG. 4 is a view similar to FIG. 3 but showing the base layer at a further step in the process of being fabricated for assembly to another portion of that valve, i.e., the cover layer; and

FIG. 5 is a view similar to FIGS. 3 and 4, but showing the cover layer of the valve.

### DETAILED DESCRIPTION OF THE PREFERRED EMBODIMENT

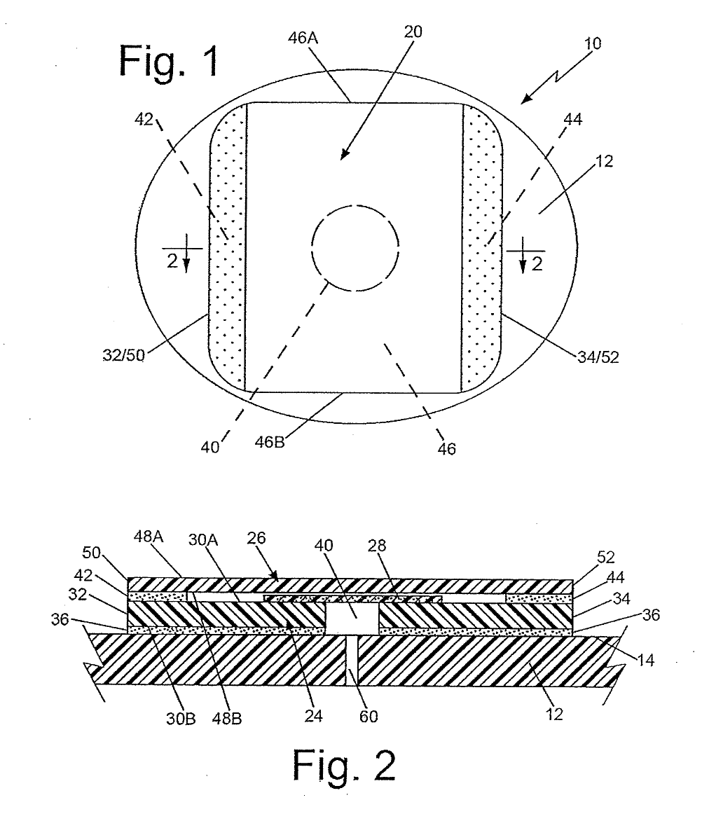

Referring now to the various figures of the drawing wherein like reference characters refer to like parts, there is shown at 10 in FIG. 1 one exemplary embodiment of a package, e.g., a flexible bag, including a one-way valve 20 constructed in accordance with this invention. It should be pointed out at this juncture that this invention contemplates a variety of embodiments of the valve 20, all of which are particularly suitable for use with a flexible package 10 to enable gases to vent out of the package when the pressure within the package reaches a predetermined threshold. In the embodiment shown in FIG. 1, only a portion of the wall 12 of the bag 10 is shown.

One preferred application for the subject valves is for flexible packaging designed to hold roasted coffee, either whole bean or ground, since such products typically de-gas. For such applications, the package 10 is formed of a web of flexible material having one or multiple layers to prevent the ingress of oxygen into the package, while also preventing coffee flavor components from escaping the package. To that end, as is a common practice, the package on which the subject valve is mounted, may be formed of a variety of high barrier plastics and/or foil materials as required by the weight of coffee and its method of distribution. While the valves of this invention are described in the context of use on packages for coffee, it should be clear the subject invention should not be deemed to be limited to any specific types of flexible packages or the material forming them.

The valve 20 is arranged to be mounted on the outer surface 14 (FIG. 2) of any portion of the wall 12 making up the package. In accordance with one preferred aspect of this invention the packages are formed from continuous web or tube of film stock to which a series of one-way valves 20 are applied at spaced locations along the web and then the web with the valves secured thereto is rolled up onto a reel (not shown). The continuous web of packages can be unreeled off of the reel, by a converter, and the individual packages, cut, filled and sealed utilizing any type of conventional filling and sealing equipment.

As will be apparent from the discussion to follow, each valve 20 is very simple in construction, and is easy to fabricate and assemble. In particular, as best seen in FIG. 2 the valve 20 comprises three basic components, namely, a thin film base member or layer 24, a thin flexible cover member or layer 26 and a fluid layer 28.

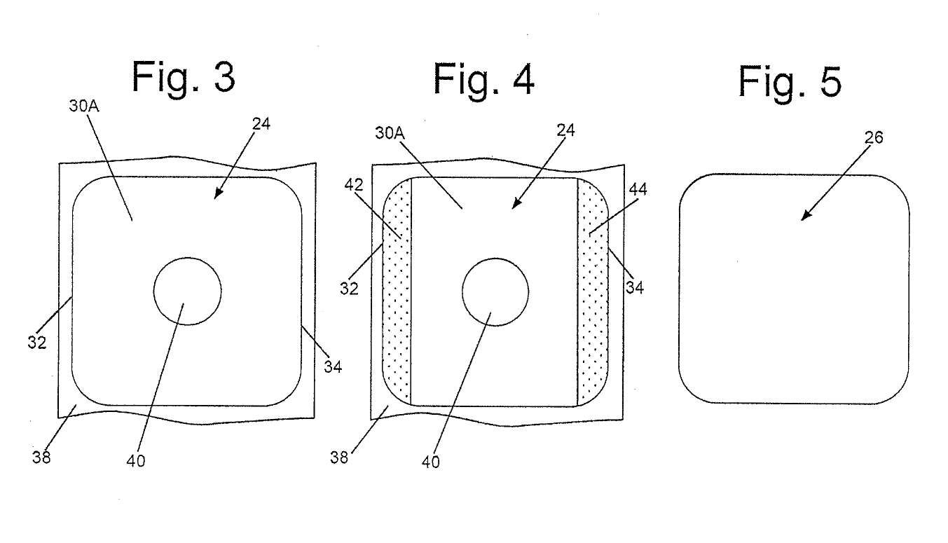

The base layer 24 is best seen in FIGS. 2 and 3 and is formed of a thin, flexible plastic material, e.g., 50 micron thick polyester film. The base layer can have any shape or profile and be of any suitable size. In the exemplary embodiment shown it is of generally square shape (e.g., 20 mm×20 mm), with rounded corners. The base layer includes a first or top side 30A and a second or bottom side 30B a first edge 32 and an opposed edge 34. The bottom side 30B of the base layer includes a pressure sensitive adhesive layer 36. That adhesive layer is arranged to releasably secure the base layer 24 on a carrier web 38 (FIG. 3). The carrier web 38 serves as a means for carrying a series of base layers 24 to a station (not shown) where each base layer 24 is joined to a respective cover layer 26. To that end, the carrier web 38 is a thin strip of any suitable material, e.g., 25 micron thick siliconized polyester release film on which a series of base layers 24 are disposed at spaced locations on the web and are temporarily held in place by the pressure sensitive adhesive 36 on the bottom side of the base layer.

An opening or hole 40 is provided, e.g., die-cut, in the center of the base layer 24 and extends through the entire thickness of the base layer, i.e., from the bottom side 30B to the top side 30A. The hole can be of any suitable size and serves as the vent or port through which gases within the package 10 may escape to the ambient atmosphere when the valve opens (as will be described later). In the exemplary embodiment the hole 40 is 7 mm in diameter. A pair of strips 42 and 44 of an adhesive is applied to the top surface 30A of the base layer 24 contiguous with the edges 32 and 24, respectively. The strips 42 and 44 serve to fixedly secure the cover layer 26 to the base layer to form a channel 46 (to be described later) therebetween as shown in FIGS. 1 and 2. The channel 46 is in fluid communication with the hole 40 and serves as the situs or residence for the fluid layer 28.

The adhesive strips 42 and 44 can be formed of any suitable material. One particularly suitable adhesive is 2.5 micron thick polyurethane adhesive. Moreover, the strips can be of any suitable width, depending upon the size of the valve and the diameter of the hole 40. In the exemplary embodiment each strip is approximately 4 mm wide, so that the channel 46 is approximately 12 mm wide.

The cover layer 26 is best seen in FIG. 5 and comprises an un-apertured or impermeable member. To that end, it is formed of a thin, flexible plastic material, e.g., polyester film, but doesn't include any hole like the base layer. Moreover, it is preferred that the thickness of the cover layer be substantially less, e.g., 50%, than the thickness of the base layer, since the portion of the cover layer contiguous with the channel 46 forms a portion of the valve that flexes to enable gases to flow out of the channel to the ambient atmosphere when the valve opens. Thus, in the exemplary embodiment the thickness of the cover layer 26 is 25 micron thick polyester film. Moreover, the cover layer is preferably of the same size and shape as the base layer so that when it is secured to the base layer the two layers are coextensive. Thus, in the exemplary embodiment shown the cover layer 26 is also of a generally square shape (e.g., 20 mm'320 mm), with rounded corners. The cover layer 26 also includes a first or top side 48A and a second or bottom side 48B, a first edge 50 and an opposed edge 52.

The cover layer 26 is disposed on top of the base layer 24 and over the hole 40 to cover that hole. The adhesive strips 42 and 44 on the base layer serve to permanently join the portions of the bottom side 48B of the cover layer contiguous with the edges 50 and 52 to the portions of the top side 30A of the base layer contiguous with the edges 32 and 34, respectively. This action forms the heretofore identified channel 36 between the portions of the cover layer and base layer between the adhesive strips 42 and 44. Since those portions of the cover layer and base layer are not secured to each other, the ends 46A and 46B of the channel 46 are openable, i.e., they can flex open.

The layer of fluid 28 is located within the channel and serves to hold the channel in a closed state. In that state the portions of the cover layer 26 contiguous with the ends 46A and 46B of the channel and the portions of the base layer contiguous with the ends 46A and 46B of the channel are in abutment so that the ambient atmosphere cannot gain ingress into the valve through the ends of the channel. The composition of the fluid can be any suitable flowable material, such as used in some of the prior art valves discussed above. In one preferred exemplary embodiment of this invention the fluid 28 is oil, e.g., 5 mg @1000 cps viscosity silicone oil. The silicone oil is introduced into the valve (as will be described later during the discussion of the assembly of the valve) so that it migrates across the top side 30A of the base layer 24 contiguous with the opening 40 as shown in FIG. 2 and thus creates a releasable bond between the films forming the cover and base layers. This completes the assembly of the valve.

The valve is arranged to be fixedly secured over an aperture or vent hole 60 in the wall 12 of the package 10. The vent hole 40 is in fluid communication with the interior of the package in which the product to be held is located. The vent hole can be of any size, e.g., 1 mm or may be a group of very small pin-holes located within the perimeter of the hole 40. The hole 40 in the base wall of the valve is in fluid communication with the vent hole 60 and the valve 20 is fixedly secured to the outside surface of the wall 12 by the adhesive layer 36 on the bottom side 30B of the base layer. Preferably the hole 40 in the valve 20 is axially aligned with the vent hole 60 in the package 10, but such an arrangement is not mandatory so long as they are in fluid communication with each other.

As should be appreciated from the foregoing by those skilled in the art, in the event that there is overpressure in the package, e.g., if the package contains coffee which degasses and if the pressure of the gasses within the package reach a predetermined (overpressure) level, that pressure breaks the releasable bond between the silicone oil and the contiguous portions of the cover layer and base layer, so that the cover layer is forced to lift up, e.g., it flexes or bows, thereby opening the channel. Thus, the gasses within the package can then flow through the vent 60 and the hole 40 into the channel 36 and out its open ends to vent to the ambient atmosphere. Once the pressure within the package is relieved, i.e., it drops below that threshold, the natural resiliency of the film making up the cover layer causes it to flex back to its initial (i.e., planar) state, whereupon the silicone oil adheres the bottom side of the cover layer to the top side of the base layer, thereby re-closing the channel and the valve.

As should be appreciated from the foregoing the one-way valve of this invention is both thin and flexible enabling it to be applied to packaging material and prevent leakage through the valve even when bended. In addition, the valve is thin enough to be pre-applied to packaging material and wound onto a roll without causing significant problems with roll formation. In pre-applied format, this invention simplifies the manufacture of a valve package since the user need only form the package and need not apply the valve. Further still, the materials used and the construction of the valve are such that it enables the valve to be adhered to the outside of a package and not the product contact side of the package, as is commonly the case with prior art valves.

One preferred method of valve construction is to cut the 7 mm diameter hole through the base layer 24, apply the 4 mm wide strips of adhesive 42 and 44 to the side 30A of the base layer 24 contiguous with the parallel edges 32 and 34, respectively, and then attach (adhesively secure) the cover layer 26 to the base layer, while the base layer is releasably secured onto the carrier web 38. The packaging material, i.e., the wall 12 of the web forming the series of packages 10, can then be punctured to create the aperture or vent 60 and the assembled valve 20 peeled from the carrier web 38. The silicone oil 28 can then be placed on the 7 mm die cut hole 40 in the valve's base layer and the valve then placed centered over the vent 60 so that the pressure sensitive adhesive 36 on the bottom side of the base layer permanently attaches the valve to the outer surface of the packaging material. The silicone oil will migrate by capillary action to the non-adhesive area between the base layer and the cover layer, as described above. Each valve of the series of packages is secured to each respective package in the same way and the web of material with the spaced apart valves thereon can then be wound up on a reel. The reel can then be used with any machine to separate the respective packages, fill them with product and seal them.

As should be appreciated from the foregoing the subject invention addresses the needs of the prior art by providing a valve that is designed to be very thin and flexible to both overcome the thickness, cost and complexity of the rigid valves and to prevent leakage when bended as occurs with the aforementioned prior art valves. Moreover, the base layer and the top layer are similar enough in thickness and construction as to stay attached to one another by the surface tension of the silicone oil even when bended. Thus, the valves of the subject invention provide the advantages of prior art valves and overcome many of their disadvantages, yet are very simple construction and easy and inexpensive to manufacture.

While the invention has been described in detail and with reference to specific examples thereof, it will be apparent to one skilled in the art that various changes and modifications can be made therein without departing from the spirit and scope thereof.

What is claimed is:

1. A one-way valve for use on package having an interior for holding a product therein, the package having a wall panel bounding an interior in which the product is to be located, said valve comprising a base layer, a cover layer and a layer of oil, said base layer being formed of a thin flexible planar sheet of plastic film having a predetermined shape, an opposed pair of edges, a first side, a second side and a hole extending through said base layer from said first side to said second side, said cover layer being formed of a thin flexible planar sheet of plastic film having a predetermined shape having an opposed pair of edges, a first side and a second side, said cover layer being disposed over said base layer with said second side of said cover layer secured to said first side of said base layer along said opposed pair of edges, whereupon portions of said cover layer and said base layer located between said opposed pair of edges are unsecured to form a channel, said channel having at least one openable end, said layer of oil being located in said channel between said base layer and said cover layer and over said hole.

2. The one-way valve of claim 1 wherein the wall panel of the package includes an outer surface and at least one aperture extending from the outer surface to the interior of the package, said valve being arranged to be secured to the outer surface of the package by a layer of adhesive interposed between said second surface of said base layer and the outer surface of the wall panel, and with said hole in said base layer in fluid communication with the aperture in the wall panel.

3. The one-way valve of claim 2 wherein said second surface of said cover layer is secured to said first surface of said base layer along said opposed pair of edges by respective interposed strips of adhesive.

4. The one-way valve of claim 1 wherein at least one of said base layer and said cover layer comprises polyester film.

5. The one-way valve of claim 1 wherein said cover layer is thinner than said base layer.

6. The one-way valve of claim 5 wherein said cover layer is approximately 25 microns thick and said base layer is approximately 50 microns thick and wherein said valve is of a generally square shape of approximately 20 mm length and 20 mm width, said hole is approximately 7 mm in diameter, the width of said channel is approximately 12 mm and said layer of oil comprises silicone oil of approximately 5 mg.

7. A flexible package comprising a wall panel bounding an interior for holding a product therein and a one-way valve in communication with said interior of said package, said wall panel including an outer surface and at least one aperture extending from said outer surface to said interior of said package, said valve comprising a base layer, a cover layer and a layer of oil, said base layer being formed of a thin flexible planar sheet of plastic film having a predetermined shape, an opposed pair of edges, a first side, a second side and a hole extending through said base layer from said first side to said second side, said cover layer being formed of a thin flexible planar sheet of plastic film having a predetermined shape having an opposed pair of edges, a first side and a second side, said cover layer being disposed over said base layer with said second side of said cover layer secured to said first side of said base layer along said opposed pair of edges, whereupon portions of said cover layer and said base layer located between said opposed pair of edges are unsecured to form a channel, said channel having at least one openable end, said layer of oil being located in said channel between said base layer and said cover layer and over said hole, said valve being secured to said outer surface of the package by a layer of adhesive interposed between said second surface of said base layer and said outer surface of said wall panel, and with said hole in said base layer in fluid communication with said aperture in said wall panel.

8. The package of claim 7 wherein said second surface of said cover layer is secured to said first surface of said base layer along said opposed pair of side edges by respective interposed strips of adhesive.

9. The package of claim 7 wherein at least one of said base layer and said cover layer comprises polyester film.

10. The package of claim 7 wherein said cover layer is thinner than said base layer.

11. The package of claim 10 wherein said cover layer is approximately 25 microns thick and said base layer is approximately 50 microns thick and wherein said valve is of a generally square shape of approximately 20 mm length and 20 mm width, said hole is approximately 7 mm in diameter, the width of said channel is approximately 12 mm and said layer of oil comprises silicone oil of approximately 5 mg.

12. A method of assembling a one-way valve on a flexible package, said flexible package comprising a wall panel arranged for defining a portion of an interior of the package for holding a product therein, said method comprising
(a) providing a carrier web on which a base layer formed of a thin flexible planar sheet of plastic film is releasably mounted, said base layer having a predetermined shape, an opposed pair of edges, a first side, a second side;
(b) forming a hole through said sheet of said base layer from said first side to said second side;
(c) applying respective strips of adhesive on said first side of said base layer adjacent respective ones of said opposed pair of side edges;
(d) providing a cover layer formed of a thin flexible planar sheet of plastic and having a predetermined shape, an opposed pair of edges, a first side and a second side;
(e) disposing said cover layer over said base layer to form said valve, whereupon said adhesive strips adhesively secure said first side of said base layer to said second side of said cover layer along said opposed pair of edges, with portions of said cover layer and said base layer located between said opposed pair of edges being unsecured to form a channel, said channel having at least one openable end;
(f) providing an aperture in said wall panel of said package, said wall panel having an outer surface;
(g) introducing a body of oil into said channel; and
(h) removing said valve from said carrier web and adhesively securing said valve to said outer surface of said wall panel.

13. The method of claim 12 wherein said base layer comprises a pressure sensitive adhesive located on said second side of said base layer, said pressure sensitive adhesive releasably securing said base layer to said carrier web, said pressure sensitive adhesive remaining on said second side of said base layer after said valve is removed from said carrier web, whereupon said pressure sensitive adhesive adhesively secures said valve to said outer surface of said wall panel.

14. The method of claim 12 wherein said body of oil is introduced into said channel by applying it to said hole before said valve is secured to said outer surface of said wall panel.

15. The method of claim 12 wherein said body of oil is introduced into said channel by applying it to said hole before said valve is secured to said outer surface of said wall panel.

16. The method of claim 12 wherein plural base layers are disposed at spaced apart locations on said carrier web to be secured to plural cover layers to form a plurality of valves.

17. The method of claim 16 wherein a series of wall panels for forming respective flexible packages are provided in a continuous strip, and wherein said plurality of valves are applied to said series of wall panels.

18. The method of claim 17 wherein said continuous strip of flexible packages with said valves secured thereto are rolled up into a reel.

19. The method of claim 12 wherein said carrier web comprises siliconized polyester release film.

20. The method of claim 13 wherein at least one of said base layer and said cover layer comprises polyester film.

21. The method of claim 19 said cover layer is thinner than said base layer.

22. The method of claim 21 wherein said cover layer is approximately 25 microns thick and said base layer is approximately 50 microns thick and wherein said valve is of a generally square shape of approximately 20 mm length and 20 mm width, said width of said channel is approximately 12 mm, said hole is approximately 7 mm in diameter and said body of oil comprises silicone oil of approximately 5 mg.
